(19) United States
(12) Patent Application Publication
(10) Pub. No.: US 2026/0181411 A1
(43) Pub. Date: Jun. 25, 2026

(54) METHOD AND APPARATUS FOR ACCESSING TO A COMMUNICATION NETWORK

(71) Applicant: Nokia Technologies Oy, Espoo (FI)

(72) Inventors: Navin HATHIRAMANI, Dallas, TX (US); Samuli Heikki TURTINEN, Oulu (FI)

(21) Appl. No.: 19/126,760

(22) PCT Filed: Oct. 6, 2023
(86) PCT No.: PCT/IB2023/060063

§ 371 Date: May 2, 2025

Related U.S. Application Data
(60) Provisional application No. 63/422,553, filed on Nov. 4, 2022.

(51) Int. Cl. H04W 16/28; H04W 72/21; H04W 72/23

(52) U.S. Cl. CPC H04W 16/28; H04W 72/21; H04W 72/23

(57) ABSTRACT

A terminal device receives a message over a paging channel from a network device and determines, based on the message, whether the terminal device is allowed to access or is restricted from accessing a cell or one or more beams of the cell associated with the network device. The network device transmits the message over a paging channel to the terminal device. A terminal device receives a message over a paging channel from a network device, and determines, based on the message, whether the terminal device is allowed to employ relaxed measurements for accessing a cell or one or more beams of the cell associated with the network device. The network device transmits the message to the terminal device.

### TECHNICAL FIELD

Exemplary embodiments herein relate generally to wireless communications and, more specifically, relates to a method and apparatus for accessing to a communication network.

### BACKGROUND

In a cellular system, a wireless device, commonly referred to as a User Equipment (UE), is sent paging from the wireless network for a variety of reasons. For instance, paging can bring a UE from an Idle mode to a Connected mode, such as to receive a voice call.

There are times when paging could be used for purposes other than mobile origination or mobile termination of calls.

### BRIEF SUMMARY

This section is intended to include examples and is not intended to be limiting.

In an exemplary embodiment, a method is disclosed that includes at a terminal device, receiving a message over a paging channel from a network device. The method also includes determining, based on the message, whether the terminal device is allowed to access or is restricted from accessing a cell or one or more beams of the cell associated with the network device.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: at a terminal device, receiving a message over a paging channel from a network device; and determining, based on the message, whether the terminal device is allowed to access or is restricted from accessing a cell or one or more beams of the cell associated with the network device.

An exemplary computer program product includes a computer-readable storage medium bearing instructions that, when executed by an apparatus, cause the apparatus to perform at least the following: at a terminal device, receiving a message over a paging channel from a network device; and determining, based on the message, whether the terminal device is allowed to access or is restricted from accessing a cell or one or more beams of the cell associated with the network device.

In another exemplary embodiment, an apparatus comprises means for performing: at a terminal device, receiving a message over a paging channel from a network device; and determining, based on the message, whether the terminal device is allowed to access or is restricted from accessing a cell or one or more beams of the cell associated with the network device.

In an exemplary embodiment, a method is disclosed that includes transmitting, by a network device and to a terminal device, a message over a paging channel, wherein the message indicates whether the terminal device is allowed to access or is restricted from accessing a cell or one or more beams of the cell associated with the network device.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: transmitting, by a network device and to a terminal device, a message over a paging channel, wherein the message indicates whether the terminal device is allowed to access or is restricted from accessing a cell or one or more beams of the cell associated with the network device.

An exemplary computer program product includes a computer-readable storage medium bearing instructions that, when executed by an apparatus, cause the apparatus to perform at least the following: transmitting, by a network device and to a terminal device, a message over a paging channel, wherein the message indicates whether the terminal device is allowed to access or is restricted from accessing a cell or one or more beams of the cell associated with the network device.

In another exemplary embodiment, an apparatus comprises means for performing: transmitting, by a network device and to a terminal device, a message over a paging channel, wherein the message indicates whether the terminal device is allowed to access or is restricted from accessing a cell or one or more beams of the cell associated with the network device.

In an exemplary embodiment, a method is disclosed that includes at a terminal device, receiving a message over a paging channel from a network device. The method also includes determining, based on the message, whether the terminal device is allowed to employ relaxed measurements for accessing a cell or one or more beams of the cell associated with the network device.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: at a terminal device, receiving a message over a paging channel from a network device; and determining, based on the message, whether the terminal device is allowed to employ relaxed measurements for accessing a cell or one or more beams of the cell associated with the network device.

An exemplary computer program product includes a computer-readable storage medium bearing instructions that, when executed by an apparatus, cause the apparatus to perform at least the following: at a terminal device, receiving a message over a paging channel from a network device; and determining, based on the message, whether the terminal device is allowed to employ relaxed measurements for accessing a cell or one or more beams of the cell associated with the network device.

In another exemplary embodiment, an apparatus comprises means for performing: at a terminal device, receiving a message over a paging channel from a network device; and determining, based on the message, whether the terminal device is allowed to employ relaxed measurements for accessing a cell or one or more beams of the cell associated with the network device.

In an exemplary embodiment, a method is disclosed that includes, at network device, transmitting a message over a paging channel to a terminal device. The message indicates whether the terminal device is allowed to employ relaxed measurements for accessing a cell or one or more beams of the cell associated with the network device.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: at network device, transmitting a message over a paging channel to a terminal device, the message indicating whether the terminal device is allowed to employ relaxed measurements for accessing a cell or one or more beams of the cell associated with the network device.

An exemplary computer program product includes a computer-readable storage medium bearing instructions that, when executed by an apparatus, cause the apparatus to perform at least the following: at network device, transmitting a message over a paging channel to a terminal device, the message indicating whether the terminal device is allowed to employ relaxed measurements for accessing a cell or one or more beams of the cell associated with the network device.

In another exemplary embodiment, an apparatus comprises means for performing: at network device, transmitting a message over a paging channel to a terminal device, the message indicating whether the terminal device is allowed to employ relaxed measurements for accessing a cell or one or more beams of the cell associated with the network device.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 is an example of a bitmap used for short messages;

FIG. 3 illustrates an example of beam-based cell access restrictions;

FIG. 4 is a logic flow diagram performed by a user equipment for paging-based backoff indication;

FIG. 4A is another logic flow diagram similar to FIG. 4 performed by a user equipment for paging-based backoff indication; and

FIG. 5 is a logic flow diagram performed by a network device for paging-based backoff indication and corresponds to FIG. 4;

FIG. 5A is another logic flow diagram similar to FIG. 5 performed by a network device for paging-based backoff indication, and this figure corresponds to FIG. 4A;

FIG. 6 is a signaling diagram of an example where a UE misses the paging with the short/paging message enabling/disabling access restriction;

FIG. 7 is an example where the UE receives paging after receiving an access restriction;

FIG. 8 illustrates additional examples; and

FIG. 9 illustrates another example where a UE is to employ relaxed measurements.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as either “or”, “and”, or “both”.

The exemplary embodiments herein describe techniques for something (usually mirrors the Title). Additional description of these techniques is presented after a system into which the exemplary embodiments may be used is described.

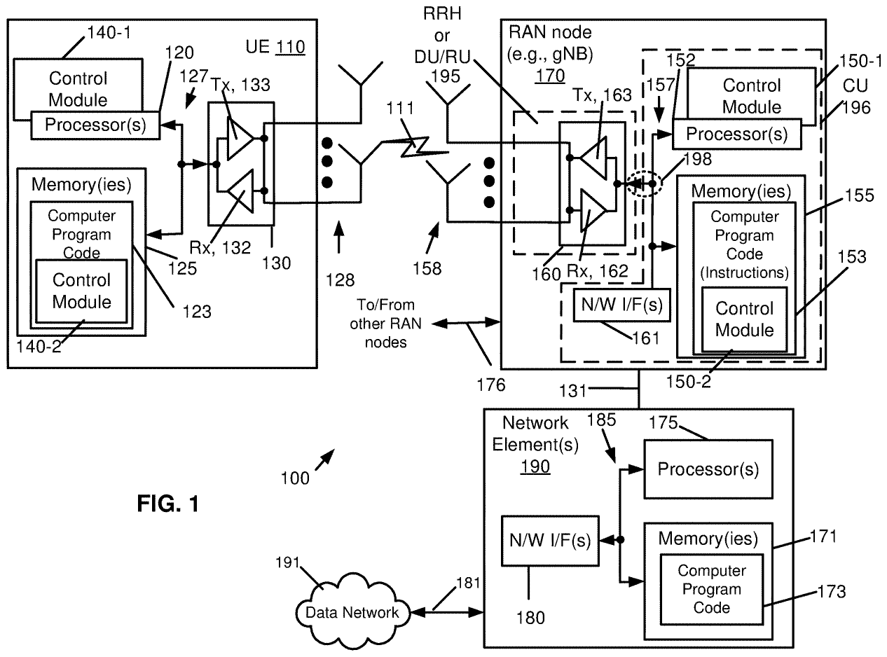

Turning to FIG. 1, this figure shows a block diagram of one possible and non-limiting exemplary system in which the exemplary embodiments may be practiced. A user equipment (UE) 110, radio access network (RAN) node 170, and network element(s) 190 are illustrated. In FIG. 1, a user equipment (UE) 110 is in wireless communication with a wireless network 100. A UE is a wireless, typically mobile terminal device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 is a base station that provides access by wireless devices such as the UE 110 to the wireless network 100. The RAN node 170 is typically referred to as a gNB, although this is one example of a network device as described below. The RAN node 170 may be a network device such as, for instance, a base station for 5G, also called New Radio (NR). In 5G, the RAN node 170 may be network device such as a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by one gNB-DU. The gNB-DU terminates the F1 interface 198 connected with the gNB-CU. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU 195 and the CU 196, or be implemented solely in the DU 195.

The one or more network interfaces 161 communicate over a network such as via the links 176 and 131. Two or more RAN nodes 170 communicate using, e.g., link 176. The link 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that the base station that forms the cell will perform the functions. The cell makes up part of a base station. That is, there can be multiple cells per base station. For instance, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a data network 191, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor-based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general-purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110, as a terminal device, can include, but are not limited to, cellular telephones such as smart phones, tablets, personal digital assistants (PDAs) having wireless communication capabilities, portable computers having wireless communication capabilities, vehicles with a modem device for wireless V2X (vehicle-to-everything) communication, image capture devices such as digital cameras having wireless communication capabilities, gaming devices having wireless communication capabilities, music storage and playback appliances having wireless communication capabilities, Internet appliances (including Internet of Things, IoT, devices) permitting wireless Internet access and possibly browsing, IoT devices with sensors and/or actuators for automation applications with wireless communication tablets with wireless communication capabilities, as well as portable units or terminals that incorporate combinations of such functions.

Having thus introduced one suitable but non-limiting technical context for the practice of the exemplary embodiments, the exemplary embodiments will now be described with greater specificity. An overview of the technological area is described now.

Under high loads, wireless networks 100 may desire to restrict the access to cells to only certain users, access classes, slices or services. This is enabled in 5G via the Unified Access Control (UAC) framework specified in 3GPP TS 22.261.

This framework applies to all UE states (RRC_IDLE, RRC_INACTIVE and RRC_CONNECTED) for NR. The NG-RAN 170 broadcasts barring control information associated with access categories and access identities (in case of network sharing, the barring control information can be set individually for each PLMN). The UE determines whether an access attempt is authorized based on the barring information broadcast for the selected PLMN, and the selected access category and access identity(ies) for the access attempt:
1) For NAS triggered requests, NAS determines the access category and access identity(ies);
2) For AS triggered requests, RRC determines the access category while NAS determines the access identity(ies).

The gNB 170 handles access attempts with establishment causes “emergency”, “mps-PriorityAccess” and “mcs-PriorityAccess” (i.e., emergency calls, MPS, MCS subscribers) with high priority and responds with RRC reject to these access attempts only in extreme network load conditions that may threaten the gNB stability.

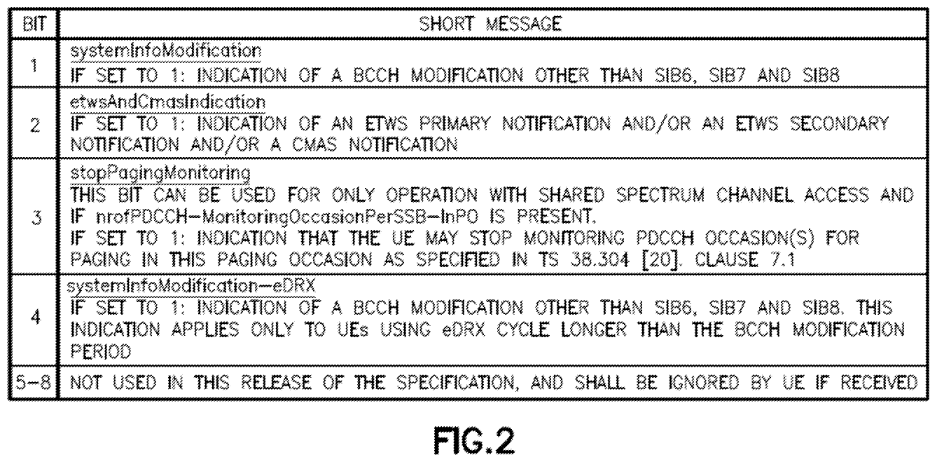

Now that an introduction to the UAC framework has been presented, an introduction to short messages is now presented. Short messages can be transmitted on PDCCH using P-RNTI with or without associated paging message via DCI (Downlink Control Information) format 1_0. The short message is composed of bitmap of 8 bits as shown in FIG. 2.

In Rel-18, a new study item for network energy savings for NR was approved in RP-213554. The following recaps the justification and the objectives of the work. This is between opening and closing quotation marks.
“4.1 Objective of SI or Core part WI or Testing part WI
The objectives of the study are the following:
1. Definition of a base station energy consumption model [RAN1]
Adapt the framework of the power consumption modelling and evaluation methodology of TR38.840 to the base station side, including relative energy consumption for DL and UL (considering factors like PA efficiency, number of TxRU, base station load, etc), sleep states and the associated transition times, and one or more reference parameters/configurations.
2. Definition of an evaluation methodology and KPIs [RAN1]
The evaluation methodology should target for evaluating system-level network energy consumption and energy savings gains, as well as assessing/balancing impact to network and user performance (e.g. spectral efficiency, capacity, UPT, latency, handover performance, call drop rate, initial access performance, SLA assurance related KPIs), energy efficiency, and UE power consumption, complexity. The evaluation methodology should not focus on a single KPI, and should reuse existing KPIs whenever applicable; where existing KPIs are found to be insufficient new KPIs may be developed as needed.
Note: WGs will decide KPIs to evaluate and how.
3. Study and identify techniques on the gNB and UE side to improve network energy savings in terms of both BS transmission and reception, which may include:
How to achieve more efficient operation dynamically and/or semi-statically and finer granularity adaptation of transmissions and/or receptions in one or more of network energy saving techniques in time, frequency, spatial, and power domains, with potential support/feedback from UE, and potential UE assistance information [RAN1, RAN2]
Information exchange/coordination over network interfaces [RAN3]
Note: Other techniques are not precluded”

This ends the the justification and the objectives of the work for RP-213554.

Any change in, e.g., the unified access control parameters would require the serving cell to broadcast a System Information (SI) change notification followed by a modification period in which the updated SI message is broadcasted. This is a rather burdensome and time-consuming procedure and, in practice, is not applied in very temporary peak-load situations.

A UE receives indications about SI modifications using short messages transmitted with P-RNTI over DCI. Since the UEs in a cell can be distributed in different beams of the cell, the SI change notification and updated SI messages would have to be broadcasted then on every beam of the cell, leading to excessive overload/overhead, especially in scenarios where access controls are required to be employed dynamically. For instance, if the load in the cell is high and access control is triggered to reduce the load, there is an increase in the load of the cell due to the described system information update procedure before the load reduction can begin. Once the load in the cell has reduced, there is a second overhead of the SI change notification and update procedure to open up the cell to more users.

Furthermore, after the UE receives the updated SI, depending on its access identity and access category, the UE may or may not be able to access the cell. If the UE is not able to access the cell after procedure or if the UE was not interested in accessing the cell, this procedure can lead to reduced UE battery life (i.e., higher power consumption) that could have been avoided.

Yet further, the SI update applies always within the whole cell and, hence, the load within each individual beam cannot be controlled using UAC in NR.

Thus, there is an issue as to how to provide efficiently access restrictions for UEs within a cell or within a beam of a cell. A beam may be a SSB (Synchronization Signal and PBCH (Physical Broadcast Channel) Block).

Deferred SIB acquisition was introduced in Rel. 8 to allow for faster redirection from LTE to 3G for circuit switch fallback via re-direction. In this configuration, the UE was only required to acquire some mandatory SIBs before attempting access to the LTE cell, and other SIBs were provided to the UE by the 3G cell in connected mode.

Also conventionally, the UE always is aware of all the fundamental information (e.g., via SIBs) to access a cell. By contrast, in certain examples herein, a UE may defer acquisition of fundamental/mandatory SIBs.

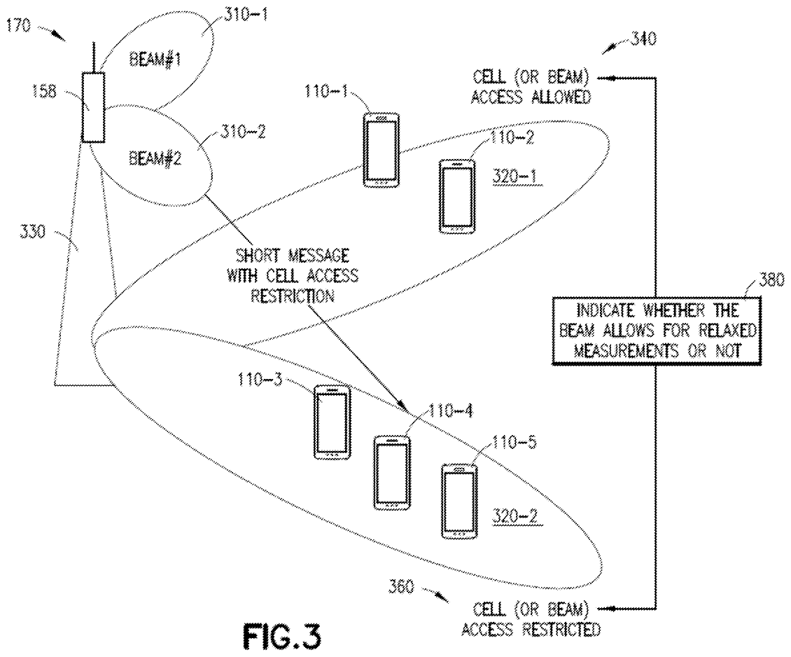

As an example, the exemplary embodiments provide a framework to proactively temporarily restrict the access to a cell/beam via paging and/or short messages and, as an additional embodiment, enable UE power saving by deferring the acquisition of SI updates. The framework enables the cell access to be beam-based as shown in FIG. 3, which illustrates an example of cell access restrictions. In FIG. 3, the gNB 170, having a tower 330 with antennas 158 (e.g., as an array of antenna elements), creates beam #1 310-1 and beam #2 310-2. Beam #1 310-1 creates or may be contained in a cell 320-1 serving UEs 110-1 and 110-2, and beam #2 310-2 creates or may be contained in a cell 320-2 that serves UEs 110-3, 110-4, and 110-5. Cell access is allowed (see reference 340) in cell 320-1, but in cell 320-2, cell access restriction (see reference 350) using short message(s) is implemented. That is, cell access is restricted (see reference 360) in cell 320-2. As a matter of example, a cell may consist of multiple beams or comprise multiple beams. For example, the cell 320-1 may be comprised or may consist of beam #1 310-1 and beam #2 310-2 that are serving UEs 110-1 and 110-2. Alternatively, for example, the cell 320-2 may be comprised or may consist of beam #1 310-1 and beam #2 310-2 that are serving UEs 110-3, 110-4 and 110-5. Thus, (one or) both reference 340 and 360 may be implemented on a per-beam basis instead of a per-cell basis.

At a high level, exemplary framework enables one or more of the following:
1) Beam-specific or cell-specific cell access restrictions, e.g., as illustrated in FIG. 3.
2) Proactively enabling or disabling cell access restrictions via short message/paging message. Short message may be transmitted using a Downlink Control Information (DCI) over Physical Downlink Control Channel (PDCCH) in a paging occasion (PO) the UE monitors for possible paging reception. Paging message may be a paging record. Paging message may be comprised in a RRC message and may be transmitted over a Physical Downlink Shared Channel (PDSCH). Paging message may be scheduled or indicated using a DCI over PDCCH in a PO the UE monitors for possible paging reception based on which the UE attempts to decode the paging message in the PDSCH.
3) Network-controlled deferred UE acquisition of updated system information until the UE needs to access the cell, which can also be applied on a per-beam basis.

The means proposed herein may also be exploited in NW energy saving schemes, where beam/cell level muting/DTX/DRX of cell/beam is pursued.

Note that as per current specifications, if the serving cell does not send a short message indicating the modification of SI messages (i.e., no system information change is performed), then some UEs may still re-acquire the SI messages if they do not have valid versions of these, e.g., they are more than three hours old.

In another exemplary embodiment, the short message signaling could be used to indicate a UE is allowed to employ, for example, a relaxed measurement scheme for the cell beams. In this embodiment, the short message would indicate (see block 380) whether the beam allows for relaxed measurements or not in references 340/360. These relaxed measurements for certain beams, such as the SSB beam, could be employed by the gNB when the gNB decides to employ power saving modes and for example reduces the number of active antenna elements which are used for transmission of a beam or the frequency with which a beam is transmitted. The relaxed measurements could entail the UE performing measurements evaluations of the relaxed beams in a different manner. For example, the UE, upon determining that relaxed measurements are enabled, could employ different thresholds from normal when evaluating cell (re)selection procedures. Furthermore, if the UE determination of relaxed measurements indicates this is only for certain measurement occasions, then the UE could either report separate measurements for relaxed and non-relaxed measurements, or the UE could report a single measurement indicating the use of relaxed measurements. For the relaxed measurements, the UE may apply a different measurement criterion for a beam of the cell or the cell, relative to measurement criteria for other beams or other cells.

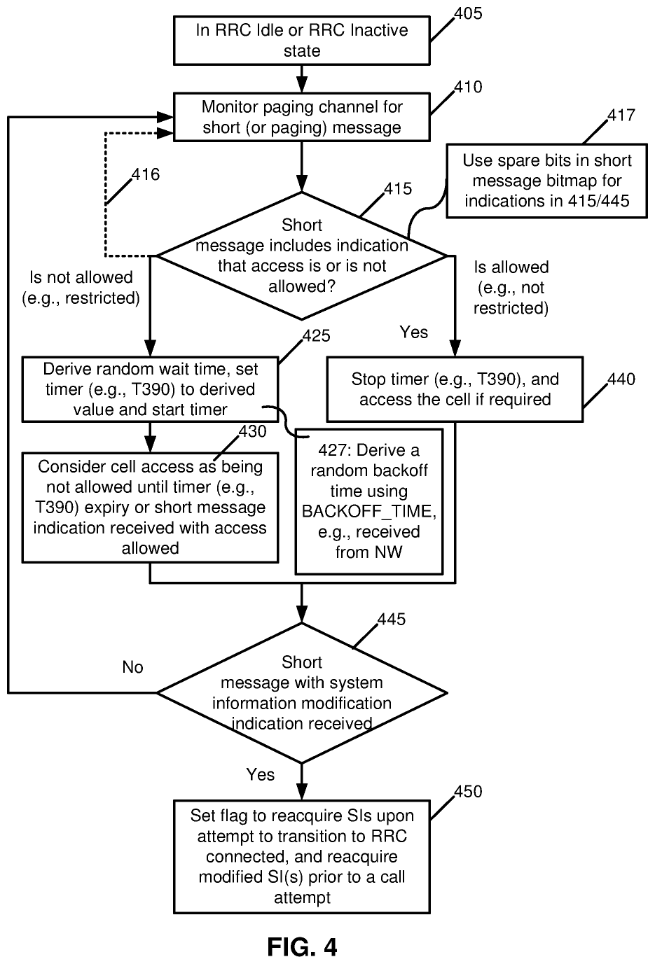

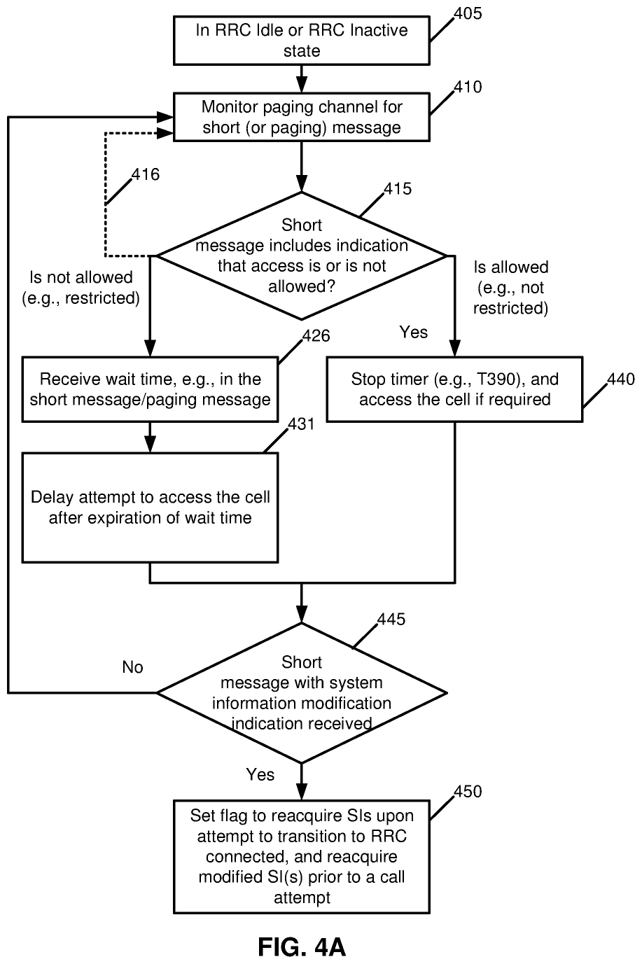

Further details are described in part in conjunction with FIG. 4, which is a logic flow diagram performed by a user equipment for paging-based backoff indication. FIG. 4 also illustrates the operation of an exemplary method or methods, a result of execution of computer program instructions embodied on a computer readable memory, functions performed by logic implemented in hardware, and/or interconnected means for performing functions in accordance with exemplary embodiments. The blocks in FIG. 4 are assumed to be performed by the UE 110, e.g., under control of the control module 140 at least in part.

A UE in an Idle or Inactive state (see block 405) may be indicated using a short message over DCI or a paging message transmitted over PDSCH. The UE monitors the paging channel in block 410, e.g., to receive this information. The UE 110 in block 415 determines whether a short (or paging) message includes indication that access is or is not allowed. This is also considered to be a restriction, e.g., access not being allowed is a restriction, whereas access being allowed is not restrictive. Note that while short messages are primarily discussed with these figures, paging messages may instead be used.

One possibility is that access to the cell is restricted or not allowed, as “is not allowed” in block 415. In this case, the UE may either wait for an indication of access to the cell being allowed (see reference 416 where the flow proceeds to block 410) or the UE may start a timer, e.g., T390 or the like, with a value derived based on its latest acquired SI information. For example, the timer value may be defined based on the following formula: T390=(0.7+0.6*rand)*uac_Barring Time, where:
rand is a random number drawn from a uniform distribution of range 0 to 1;
uac_Barring Time is derived from the latest SI value stored for the serving cell in the UE. Any other parameter may also be applied.

This is illustrated by block 425. In block 430, the UE considers cell access as being not allowed until timer (e.g., T390) expiry or a short message indication is received with access allowed.

In one option, the UE may derive (see block 427) a random backoff time between 0 (zero) and BACKOFF_TIME for which time the UE is not allowed to attempt an access to the cell in case RRC establishment is triggered. The BACKOFF_TIME could be provided by the NW using broadcast signaling or within the paging message/short message where the indication to backoff is provided. In one option, an index for BACKOFF_TIME could be indicated in the short message/paging message which points to a predefined BACKOFF_TIME defined in a specification or broadcasted by the NW.

Another possibility is that access to the cell is allowed, indicated by “is allowed” for block 415. In this case, in response to reception of this indication, the UE 110 stops the timer (e.g., T390 timer or the like), if the timer was running or if the timer is applied, and the UE assumes the cell is available for access and may access the cell if required. See block 440.

In one embodiment, for both the above scenarios, if the short/paging message indicates a change in system information message(s) (see block 445), the UE may defer the acquisition of the updated SI(s) until the UE has a need to access to the cell. In this case the UE should re-acquire modified SI(s) prior to a call attempt. See block 450.

In one embodiment, the proposed framework could utilize the spare bits in DCI of the short message to enable the above indications. That is, the UE would examine the currently spare bits for a new indication for block 415. This is illustrated by block 417. Block 417 also indicates the currently spare bits could be used additionally or alternatively for block 445.

In another option, the NW indicates the wait time in the short message/paging message which the UE waits before attempting to access the cell. See FIG. 4A, which is another logic flow diagram similar to FIG. 4 performed by a user equipment for paging-based backoff indication. In block 426, the UE receives the wait time, e.g., in the short message/paging message from block 415. The UE waits in block 431, as the UE delays an attempt to access the cell until after expiration of the wait time.

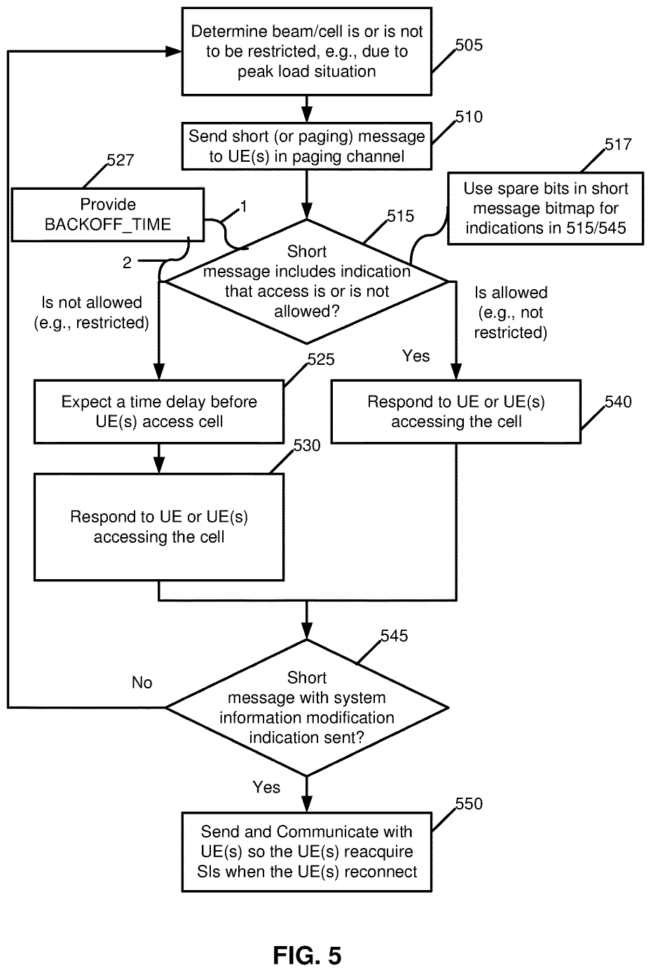

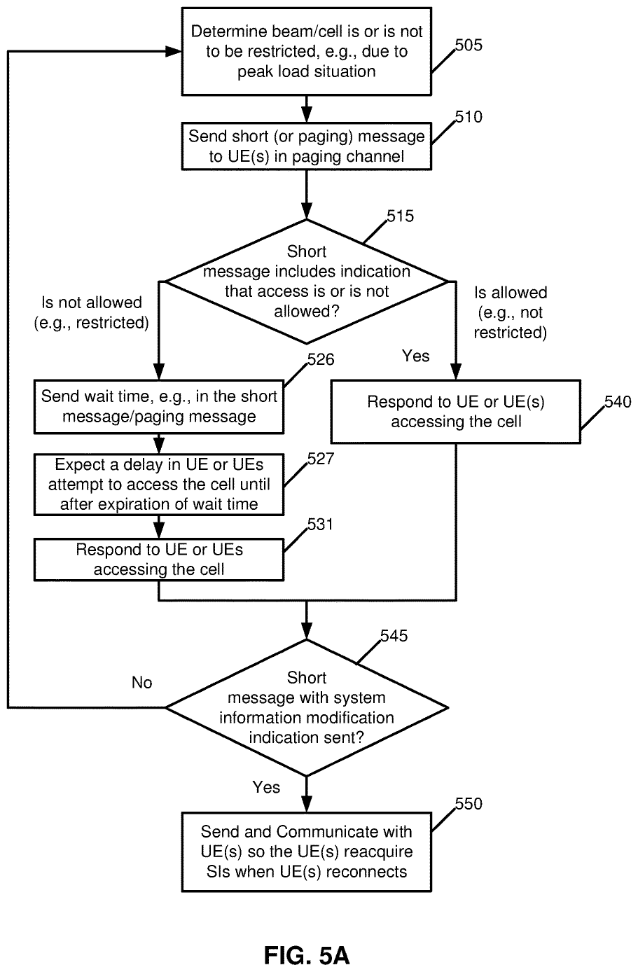

Turning to FIG. 5, this figure is a logic flow diagram performed by a network device for paging-based backoff indication and corresponds to FIG. 4. That is, while FIG. 4 illustrates the operations taken by a UE, FIG. 5 illustrates the operations taking place on the other side of the communication, by a network device such as gNB 170. FIG. 5 also illustrates the operation of an exemplary method or methods, a result of execution of computer program instructions embodied on a computer readable memory, functions performed by logic implemented in hardware, and/or interconnected means for performing functions in accordance with exemplary embodiments. The blocks in FIG. 5 are assumed to be performed by the gNB 170 (or another network device), e.g., under control of the control module 150 at least in part.

In block 505, the gNB 170 determines whether a beam or a cell is or is not to be restricted, e.g., due to a peak load situation on the beam/cell. That is, the NW (in this case, the gNB 170) determines that it wants to restrict access for a certain beam of a cell or a cell and that determination is applied to all the UEs under the beam/cell. In block 510, the gNB 170 sends a short (or paging) message to the UE(s) in the beam/cell in the paging channel. What happens next is based on (block 515) whether the short message includes an indication that access is or is not allowed.

If the access is not allowed (e.g., is restricted) in block 515, the gNB 170 expects (block 525) a time delay before the UE(s) attempt to access the cell. Note that if there are multiple UEs, there could be different time delays for the UEs, since individual UEs determine random wait times, which are most likely different. At some point, e.g., defined in part by a random wait time determined by the individual UEs, the UEs should attempt to access the cell. In block 530, the gNB responds to the UE's accessing the cell, e.g., by performing normal functions for access.

If the access is allowed (e.g., is not restricted) in block 515, the gNB 170, the gNB responds to the UE or UEs accessing the cell, e.g., by performing normal functions for access in block 540. The UE(s) could access the cell at any time.

In block 545, the gNB 170 determines whether to send a short message with SI modification indication to the UE(s). If so (block 545=Yes), the gNB 170 sends the message and communicates with the UE(s) so the UE(s) reacquire SIs when the UE(s) reconnects to the NW.

In one embodiment, the proposed framework could utilize the spare bits in the short message bitmap to enable the above indications. That is, the gNB 170 would modify the currently spare bits for a new indication for block 515. This is illustrated by block 517, and this could apply to blocks 515 and/or 545.

As previously described, the UE may derive (see block 427 of FIG. 4) a random backoff time between 0 (zero) and BACKOFF_TIME for which time the UE is not allowed to attempt an access to the cell in case RRC (re)establishment is triggered. The BACKOFF_TIME could be provided (see block 527) by the NW using broadcast signaling (see reference 2 of 527) or within the paging message/short message (see reference 1 of 527) in block 515, where the indication to backoff is also provided.

FIG. 5A is another logic flow diagram similar to FIG. 5 performed by a network device for paging-based backoff indication, and this figure corresponds to FIG. 4A. In this option, the NW indicates the wait time in the short message/paging message which the UE waits before attempting to access the cell. See block 526, where the gNB 170 sends the wait time, e.g., in the short message/paging message from block 515. The gNB 170 in block 527 expects the UE or UEs to delay an attempt to access the cell until after expiration of the corresponding wait time. In block 531, the gNB 170 response to the UE or UEs access the cell, e.g., in a normal access pattern.

In one embodiment, a UE may miss the paging with the short/paging message enabling/disabling access restrictions. In these cases, when the short/paging message restricts access, the UE may be rejected or not allowed to access the network when it attempts to transition to RRC connected mode. For the scenarios where the missed paging indication is to inform of access allowed to the network, the T390 timer (or similar) ensures the UE is not stuck in the incorrect state eternally.

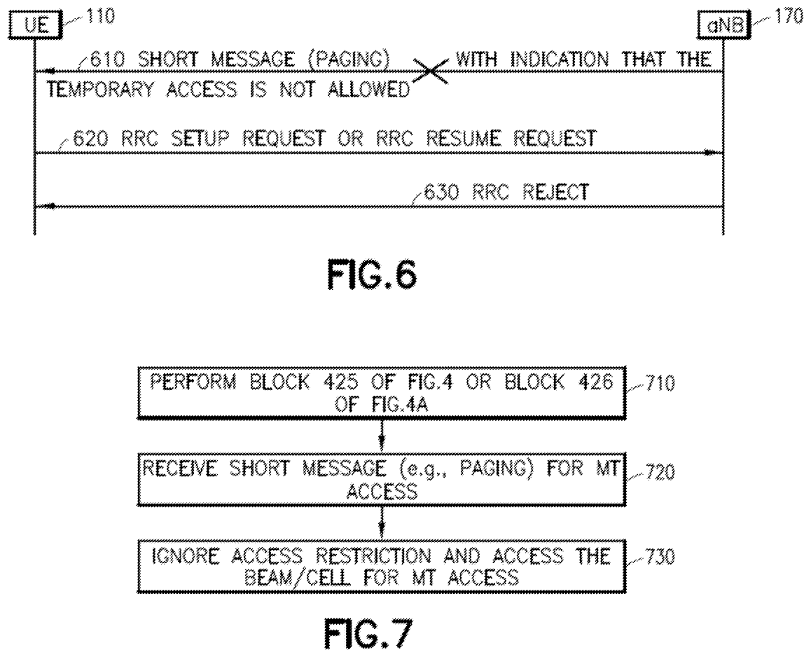

FIG. 6 is a signaling diagram of an example where a UE misses the paging with the short/paging message enabling/disabling access restriction. In signaling 610, the gNB 170 sends a short message (e.g., paging) with an indication that temporary access is not allowed. The “X” indicates the UE 110 does not receive this. The UE sends a setup request or RRC resume request in signaling 620. The gNB 170 responds in signaling 630 with an RRC reject because the UE is not supposed to access the beam/cell at this time.

In one embodiment, if the UE receives a paging from the NW requesting for the UE to establish connection with the NW, the access restrictions may be ignored and UE can initiate the call with a mobile-terminated access cause. FIG. 7 is an example where the UE receives paging after receiving an access restriction. In FIG. 7, the UE 110 performs block 425 of FIG. 4 or block 426 of FIG. 4A. This occurs in block 710. That is, the UE is not allowed to access the beam/cell for a particular time (as per blocks 425/426). In block 720, the UE receives (within the time period, such as the wait time, for delaying access) a short message (e.g., paging) for mobile-terminated (MT) access, and in block 730, the UE ignores the access restriction and instead accesses the beam/cell for MT access.

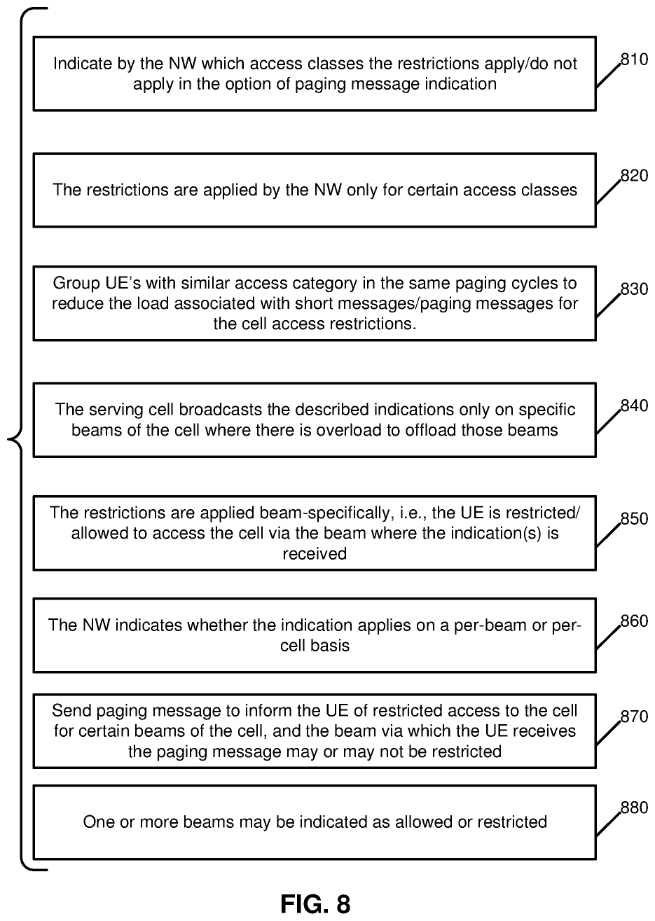

Refer to FIG. 8 for other examples. Note that any flowchart, such as FIGS. 7-9 herein, illustrates the operation of an exemplary method or methods, a result of execution of computer program instructions embodied on a computer readable memory, functions performed by logic implemented in hardware, and/or interconnected means for performing functions in accordance with exemplary embodiments. The blocks in these figures are performed by UE 110 or a network device such as gNB 170.

In one embodiment, the NW could also indicate which access classes the restrictions apply/do not apply in the option of paging message indication. See block 810. In one embodiment, the restrictions may be applied by the NW only for certain access classes and, e.g., emergency calls are allowed, but other access classes are restricted for certain beams/cells. See block 820.

In one embodiment, with the proposed framework the serving cell could, e.g., group UE's with similar access category in the same paging cycles to reduce the load associated with short messages/paging messages for the cell access restrictions. See block 830. That is, the NW may not provide such restrictions in each PO (Paging Occasion) within the cell/beam.

Furthermore, as stated above, the serving cell could broadcast the described indications only on specific beams of the cell where there is overload to offload those beams. See block 840. For instance, for TDD deployments where MU-MIMO is employed, if a certain beam is overloaded with users, the serving cell could proactively pre-empt new users from accessing the cell via this beam.

In one embodiment, the restrictions are applied beam-specifically, i.e., the UE is restricted/allowed to access the cell via the beam where the indication(s) is received. See block 850. In one option, The NW could indicate whether the indication applies on a per-beam or per-cell basis. See block 860.

Another example is illustrated by block 870. In this example, the network sends a paging message to inform the UE of restricted access to the cell for certain beams of the cell, and the beam via which the UE receives the paging message may or may not be restricted. That is, the beam used for sending the paging message may not be one of the certain beams that are restricted.

In most examples herein, a single beam is used that is indicated as being allowed for access or as being restricted from access. Block 880 indicates another possibility, where one or more beams may be indicated as allowed or restricted. In other words, multiple certain beams could be indicated as being restricted (or allowed).

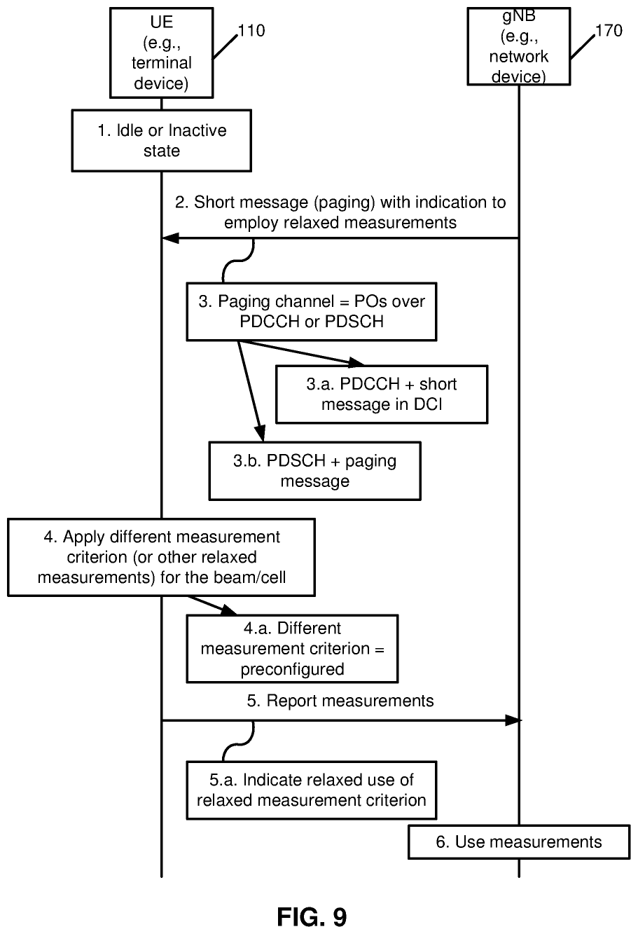

Referring now to FIG. 9, this figure illustrates another example where a UE is to employ relaxed measurements. In this example, the UE 110, e.g., as a terminal device, is in an idle or inactive state in block 1. The gNB 170, e.g., as a network device, sends a short message (paging) with indication to employ relaxed measurements, as indicated by signaling 2. The paging channel may include paging occasions (POs) over PDCCH or PDSCH, as indicated by block 3. Block 3.a. indicates the PDCCH may be used with the short message in DCI. Alternatively (or additionally), block 3.b. indicates the PDSCH may be used with a paging message. Note that block 3 and its subblocks 3.a. and 3.b. may be applied to the other flowcharts and techniques described herein.

In block 4, the UE 110 applies a different measurement criterion (or other relaxed measurements) for the beam of the cell or the cell. As indicated by block 4.a., the different measurement criterion may be preconfigured, at least before the signaling in 2 is received.

The UE 110 reports measurements in signaling 5. Block 5.a. indicates that the UE may indicate relaxed use of the measurement criterion in the signaling 5. In block 6, the gNB uses the measurements in techniques known to those skilled in this area.

Without in any way limiting the scope, interpretation, or application of the claims appearing below, a technical effect of one or more of the example embodiments disclosed herein is that the UE does not have to continuously acquire modified SIBs and can instead remain in DRX mode (or other energy saving state) while the UE is not allowed access to the cell. Another technical effect of one or more of the example embodiments disclosed herein is that exemplary embodiments enable beam-based access restrictions. Another technical effect of one or more of the example embodiments disclosed herein is that examples allow a more dynamic framework for restricting access to a cell from a time perspective, given the reduction in load from serving cell point of view.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3G third generation
3GPP third generation partnership project
5G fifth generation
5GC 5G core network
AMF access and mobility management function
AS access stratum
CU central unit
DCI downlink control information
DRX discontinuous reception
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
LTE long term evolution
MAC medium access control
MCS mission critical service
MPS multimedia priority service
MME mobility management entity
MT mobile-terminated
MU-MIMO multi-user multiple input, multiple output
NW network
NAS non-access stratum
ng or NG next generation
ng-eNB or NG-eNB next generation eNB
NR new radio
N/W or NW network
PBCH Physical Broadcast Channel
PDCCH physical downlink control channel
PDCP packet data convergence protocol
PDSCH physical downlink shared channel
PHY physical layer
PLMN public land mobile network
PO paging occasion
P-RNTI paging-radio temporary identifier
RAN radio access network
Rel release
RLC radio link control
RRH remote radio head
RRC radio resource control
RU radio unit
Rx receiver
SDAP service data adaptation protocol
SGW serving gateway
SI system information
SIB system information block
SMF session management function
SSB Synchronization Signal and PBCH (Physical Broadcast Channel) Block
TS technical specification
Tx transmitter
UAC unified access control
UE user equipment (e.g., a wireless, typically mobile device)
UPF user plane function

What is claimed is:

1. A method, comprising:
at a terminal device, receiving a message over a paging channel from a network device; and
determining, based on the message, whether the terminal device is allowed to access or is restricted from accessing a cell or one or more beams of the cell associated with the network device.

2. The method of claim 1, wherein the paging channel comprises one or more paging occasions over a physical downlink control channel, PDCCH, or a physical downlink shared channel, PDSCH, from the network device.

3. The method of claim 1 or 2, wherein the paging channel comprises one or more paging occasions over a PDCCH and wherein the message is a short message indicated in downlink control information transmitted over the PDCCH.

4. The method of claim 1 or 2, wherein the paging channel comprises one or more paging occasions over a PDSCH and wherein the message is a paging message transmitted over the PDSCH.

5. The method of any one of claims 1 to 4, wherein the terminal device is in an idle state or an inactive state during at least the receiving and determining.

6. The method of any one of claims 1 to 5, wherein:
the receiving the message comprises receiving the message via at least one beam of the cell from the network device; and
the determining further comprises determining, based on the message, whether the terminal device is allowed to access or is restricted from accessing the cell via the one or more beams of the cell.

7. The method of claim 6, wherein the at least one beam of the cell over which the message is received is one of: the at least one beam that is different from the one or more beams; or the at least one beam that is one of the one or more beams.

8. The method of any one of claims 6 or 7, further comprising:
accessing the cell via the one or more beams of the cell based on the determination.

9. The method of any one of claims 1 to 8, further comprising:
managing, in response to the message, acquisition of system information of the cell for the access to the cell or the one or more beams of the cell.

10. The method of claim 9, further comprising:
deferring or delaying the acquisition of the system information of the cell based on the message.

11. The method of claim 9, further comprising:
acquiring the system information of the cell regardless of the determination.

12. The method of any one of claims 1 to 11, wherein the message indicates a change or update in the system information.

13. The method of claim 12, further comprising:
deferring or delaying the acquisition of the change or update of the system information of the cell based on the message.

14. A method, comprising:
transmitting, by a network device and to a terminal device, a message over a paging channel, wherein the message indicates whether the terminal device is allowed to access or is restricted from accessing a cell or one or more beams of the cell associated with the network device.

15. The method of claim 14, wherein the paging channel comprises one or more paging occasions over a physical downlink control channel, PDCCH, or a physical downlink shared channel, PDSCH, to the terminal device.

16. The method of claim 14 or 15, further comprising:
determining a change or update of system information of the cell; and
indicating, to the terminal device, the change or update in the message.

17. The method of claim 16, further comprising:
using the message to manage or control the terminal device to acquire the change or update of the system information.

18. The method of claim 16 or 17, further comprising:
using the message to manage or control the terminal device to acquire the system information of the cell.

19. The method of any one of claims 14 to 18, wherein the terminal device is in an idle state or an inactive state at least while the network device performs the transmitting.

20. The method of any one of claims 14 to 19, wherein:
transmitting comprises transmitting the message via at least one beam of the cell; and
the method further comprises indicating, to the terminal device, whether the terminal device is allowed to access or restricted from accessing the cell via the one or more beams of the cell.

21. The method of claim 20, wherein the at least one beam of the cell over which the message is transmitted is one of: at least one beam that is different from the one or more beams; or at least one beam that is one of the one or more beams.

22. A method, comprising:
at a terminal device, receiving a message over a paging channel from a network device; and
determining, based on the message, whether the terminal device is allowed to employ relaxed measurements for accessing a cell or one or more beams of the cell associated with the network device.

23. The method of claim 22, wherein the paging channel comprises one or more paging occasions over a physical downlink control channel, PDCCH, or a physical downlink shared channel, PDSCH, from the network device.

24. The method of claim 22 or 23, wherein the paging channel comprises one or more paging occasions over a PDCCH and wherein the message is a short message indicated in downlink control information transmitted over the PDCCH.

25. The method of claim 22 or 23, wherein the paging channel comprises one or more paging occasions over a PDSCH and wherein the message is a paging message transmitted over the PDSCH.

26. The method of any one of claims 22 to 25, wherein the terminal device is in an idle state or an inactive state during at least the receiving and determining.

27. The method of claims 22 to 26, wherein based on the determination for relaxed measurements for the cell or the one or more beams of the cell, the terminal device applies a different measurement criterion for the one or more beams of the cell or the cell, relative to measurement criteria for other beams or other cells.

28. The method of claim 27, wherein the different measurement criterion is pre-configured by the network device for the terminal device.

29. The method of claim 27, in which the terminal device indicates the use of the relaxed measurement criterion when reporting measurements to the network device.

30. The method of any one of claim 22 to 29, wherein the beam of the cell over which the message is received is one of: a beam that is different from the one or more beams; or a beam that is one of the one or more beams.

31. A method, comprising:
at network device, transmitting a message over a paging channel to a terminal device, the message indicating whether the terminal device is allowed to employ relaxed measurements for accessing a cell or one or more beams of the cell associated with the network device.

32. The method of claim 31, wherein the paging channel comprises one or more paging occasions over a physical downlink control channel, PDCCH, or a physical downlink shared channel, PDSCH, from the network device.

33. The method of claim 31 or 32, wherein the paging channel comprises one or more paging occasions over a PDCCH and wherein the message is a short message indicated in downlink control information transmitted over the PDCCH.

34. The method of claim 31 or 32, wherein the paging channel comprises one or more paging occasions over a PDSCH and wherein the message is a paging message transmitted over the PDSCH.

35. The method of any one of claims 31 to 34, wherein the terminal device is in an idle state or an inactive state while the network performs the transmitting.

36. The method of claims 31 to 35, wherein:
transmitting comprises transmitting the message via at least one beam of the cell; and
the method further comprises indicating, to the terminal device, whether relaxed measurements for the cell or the one or more beams of the cell are to be performed, indicating the terminal device is to apply a different measurement criterion for the one or more beams of the cell or the cell, relative to measurement criteria for other beams or other cells.

37. The method of claim 36, wherein the at least one beam of the cell over which the message is transmitted is one of: at least one beam that is different from the one or more beams; or at least one beam that is one of the one or more beams.

38. The method of claim 36, wherein the different measurement criterion is pre-configured by the network device for the terminal device.

39. The method of claim 36, further comprising receiving, by the network device, measurements from the terminal device in which the terminal device indicates the use of the relaxed measurement criterion for the one or more beams of the cell or the cell.

40. A computer program, comprising instructions for performing the methods of any of claims 1 to 39, when the computer program is run on an apparatus.

41. The computer program according to claim 40, wherein the computer program is a computer program product comprising a computer-readable medium bearing instructions embodied therein for use with the apparatus.

42. The computer program according to claim 40, wherein the computer program is directly loadable into an internal memory of the apparatus.

43. An apparatus, comprising means for performing:
at a terminal device, receiving a message over a paging channel from a network device; and
determining, based on the message, whether the terminal device is allowed to access or is restricted from accessing a cell or one or more beams of the cell associated with the network device.

44. The apparatus of claim 43, wherein the paging channel comprises one or more paging occasions over a physical downlink control channel, PDCCH, or a physical downlink shared channel, PDSCH, from the network device.

45. The apparatus of claim 43 or 44, wherein the paging channel comprises one or more paging occasions over a PDCCH and wherein the message is a short message indicated in downlink control information transmitted over the PDCCH.

46. The apparatus of claim 43 or 44, wherein the paging channel comprises one or more paging occasions over a PDSCH and wherein the message is a paging message transmitted over the PDSCH.

47. The apparatus of any one of claims 43 to 46, wherein the terminal device is in an idle state or an inactive state during at least the receiving and determining.

48. The apparatus of any one of claims 43 to 47, wherein:
the receiving the message comprises receiving the message via a beam of the cell from the network device; and
the determining further comprises determining, based on the message, whether the terminal device is allowed to access or is restricted from accessing the cell via the beam of the cell.

49. The apparatus of claim 48, wherein the beam of the cell over which the message is received is one of: a beam that is different from the one or more beams; or a beam that is one of the one or more beams.

50. The apparatus of any one of claims 48 or 49, wherein the means are further configured for performing:
accessing the cell via the one or more beams of the cell based on the determination.

51. The apparatus of any one of claims 43 to 50, wherein the means are further configured for performing:
managing, in response to the message, acquisition of system information of the cell for the access to the cell or the one or more beams of the cell.

52. The apparatus of claim 51, wherein the means are further configured for performing:
deferring or delaying the acquisition of the system information of the cell based on the message.

53. The apparatus of claim 51, wherein the means are further configured for performing:
acquiring the system information of the cell regardless of the determination.

54. The apparatus of any one of claims 43 to 53, wherein the message indicates a change or update in the system information.

55. The apparatus of claim 54, wherein the means are further configured for performing:
deferring or delaying the acquisition of the change or update of the system information of the cell based on the message.

56. An apparatus, comprising means for performing:
transmitting, by a network device and to a terminal device, a message over a paging channel, wherein the message indicates whether the terminal device is allowed to access or is restricted from accessing a cell or one or more beams of the cell associated with the network device.

57. The apparatus of claim 56, wherein the paging channel comprises one or more paging occasions over a physical downlink control channel, PDCCH, or a physical downlink shared channel, PDSCH, to the terminal device.

58. The apparatus of claim 56 or 57, wherein the means are further configured for performing:
determining a change or update of system information of the cell; and
indicating, to the terminal device, the change or update in the message.

59. The apparatus of claim 58, wherein the means are further configured for performing:
using the message to manage or control the terminal device to acquire the change or update of the system information.

60. The apparatus of claim 58 or 59, wherein the means are further configured for performing:
using the message to manage or control the terminal device to acquire the system information of the cell.

61. The apparatus of any one of claims 56 to 60, wherein the terminal device is in an idle state or an inactive state at least while the network device performs the transmitting.

62. The apparatus of any one of claims 56 to 61, wherein:
transmitting comprises transmitting the message via at least one beam of the cell; and
the means are further configured for performing: indicating, to the terminal device, whether the terminal device is allowed to access or restricted from accessing the cell via the one or more beams of the cell.

63. The apparatus of claim 62, wherein the at least one beam of the cell over which the message is transmitted is one of: at least one beam that is different from the one or more beams; or at least one beam that is one of the one or more beams.

64. An apparatus, comprising means for performing:
at a terminal device, receiving a message over a paging channel from a network device; and
determining, based on the message, whether the terminal device is allowed to employ relaxed measurements for accessing a cell or one or more beams of the cell associated with the network device.

65. The apparatus of claim 64, wherein the paging channel comprises one or more paging occasions over a physical downlink control channel, PDCCH, or a physical downlink shared channel, PDSCH, from the network device.

66. The apparatus of claim 64 or 65, wherein the paging channel comprises one or more paging occasions over a PDCCH and wherein the message is a short message indicated in downlink control information transmitted over the PDCCH.

67. The apparatus of claim 64 or 65, wherein the paging channel comprises one or more paging occasions over a PDSCH and wherein the message is a paging message transmitted over the PDSCH.

68. The apparatus of any one of claims 64 to 67, wherein the terminal device is in an idle state or an inactive state during at least the receiving and determining.

69. The apparatus of claims 64 to 68, wherein based on the determination for relaxed measurements for the cell or the one or more beams of the cell, the terminal device applies a different measurement criterion for the one or more beams of the cell or the cell, relative to measurement criteria for other beams or other cells.

70. The apparatus of claim 69, wherein the different measurement criterion is pre-configured by the network device for the terminal device.

71. The apparatus of claim 69, in which the terminal device indicates the use of the relaxed measurement criterion when reporting measurements to the network device.

72. The apparatus of any one of claim 64 to 71, wherein the beam of the cell over which the message is received is one of: a beam that is different from the one or more beams; or a beam that is one of the one or more beams.

73. An apparatus, comprising means for performing:
at network device, transmitting a message over a paging channel to a terminal device, the message indicating whether the terminal device is allowed to employ relaxed measurements for accessing a cell or one or more beams of the cell associated with the network device.

74. The apparatus of claim 73, wherein the paging channel comprises one or more paging occasions over a physical downlink control channel, PDCCH, or a physical downlink shared channel, PDSCH, from the network device.

75. The apparatus of claim 73 or 74, wherein the paging channel comprises one or more paging occasions over a PDCCH and wherein the message is a short message indicated in downlink control information transmitted over the PDCCH.

76. The apparatus of claim 73 or 74, wherein the paging channel comprises one or more paging occasions over a PDSCH and wherein the message is a paging message transmitted over the PDSCH.

77. The apparatus of any one of claims 73 to 76, wherein the terminal device is in an idle state or an inactive state while the network performs the transmitting.

78. The apparatus of claims 73 to 77, wherein:
transmitting comprises transmitting the message via at least one beam of the cell; and
the means are further configured for performing: indicating, to the terminal device, whether relaxed measurements for the cell or the one or more beams of the cell are to be performed, indicating the terminal device is to apply a different measurement criterion for the one or more beam of the cell or the cell, relative to measurement criteria for other beams or other cells.

79. The apparatus of claim 78, wherein the at least one beam of the cell over which the message is transmitted is one of: at least one beam that is different from the one or more beams; or at least one beam that is one of the one or more beams.

80. The apparatus of claim 78, wherein the different measurement criterion is pre-configured by the network device for the terminal device.

81. The apparatus of claim 78, wherein the means are further configured for performing:
receiving, by the network device, measurements from the terminal device in which the terminal device indicates the use of the relaxed measurement criterion for the one or more beams of the cell or the cell.

82. The apparatus of any preceding apparatus claim, wherein the means comprises:
at least one processor; and
at least one memory storing instructions that, when executed by at least one processor, cause the performance of the apparatus.

83. An apparatus, comprising:
one or more processors; and
one or more memories storing instructions that, when executed by the one or more processors, cause the apparatus to perform at least the following:
at a terminal device, receiving a message over a paging channel from a network device; and
determining, based on the message, whether the terminal device is allowed to access or is restricted from accessing a cell or one or more beams of the cell associated with the network device.

84. An apparatus, comprising:
one or more processors; and
one or more memories storing instructions that, when executed by the one or more processors, cause the apparatus to perform at least the following:
transmitting, by a network device and to a terminal device, a message over a paging channel, wherein the message indicates whether the terminal device is allowed to access or is restricted from accessing a cell or one or more beams of the cell associated with the network device.

85. An apparatus, comprising:
one or more processors; and
one or more memories storing instructions that, when executed by the one or more processors, cause the apparatus to perform at least the following:
at a terminal device, receiving a message over a paging channel from a network device; and
determining, based on the message, whether the terminal device is allowed to employ relaxed measurements for accessing a cell or one or more beams of the cell associated with the network device.

86. An apparatus, comprising:
one or more processors; and
one or more memories storing instructions that, when executed by the one or more processors, cause the apparatus to perform at least the following:
at network device, transmitting a message over a paging channel to a terminal device, the message indicating whether the terminal device is allowed to employ relaxed measurements for accessing a cell or one or more beams of the cell associated with the network device.
